(19) United States
(12) Patent Application Publication
(10) Pub. No.: US 2008/0316747 A1
(43) Pub. Date: Dec. 25, 2008

(54) Luminaire with Louver Members

(75) Inventors: Corinne Lac, Beynost (FR); Artur Markowski, Ketrzyn (PL); Gert-Jan Bauco De Vries, La Boisse (FR); Mathew Lee Bembridge, Eindhoven (NL); Grzegorz Jurgielajtis, Ketrzyn (PL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/574,912

(22) PCT Filed: Sep. 8, 2005
(86) PCT No.: PCT/IB05/52927

§ 371 Date: Mar. 8, 2007

(30) Foreign Application Priority Data
Sep. 14, 2004 (EP) 04300596.6

(51) Int. Cl. F21V 7/00; F21V 11/02

(52) U.S. Cl. 362/290; 362/296

(57) ABSTRACT

The invention relates to a reflector for a luminaire. The reflector comprises a cavity (101) for receiving a lamp intended to emit light and, located around said cavity, a first annular louver member (201) arranged in a first direction and a second annular louver member (202) arranged in a second, opposite direction.

### FIELD OF THE INVENTION

The present invention relates to a reflector for a luminaire, said reflector comprising annular louver members. It also relates to a luminaire comprising such a reflector.

The present invention is particularly relevant for lighting, in particular outdoor lighting.

### BACKGROUND OF THE INVENTION

Patent application EP 1 074 787 describes a reflector for a luminaire. This luminaire is intended for outdoor lighting, such as illumination of squares or other public or private areas. Such a reflector is shown in FIGS. 1a and 1b, where FIG. 1a is a cross section and FIG. 1b a perspective view of said reflector. It comprises a cavity 101 for receiving a lamp, and, around said cavity, annular louver members 102. The annular louver members 102 are arranged in a downward direction, which means that light passing through the annular louver members is mainly directed downwardly, with an angle that depends on the slopes of the annular louver members 102. The main direction of light is represented by dotted arrows in FIG. 1a.

The reflector has an axis of revolution CC. The direction of annular louver members is widely used in this technical field. It is often said that a reflector with annular louver members is oriented downwardly when the majority of light that passes through said reflector has a downward component. Of course, the terms “downward” or “upward” depend on the use of the reflector. Hence, the direction of an annular louver member 102 may be more clearly defined by the direction of the component of a vector AB parallel to said annular louver member 102, said vector being directed from the axis of revolution CC to the outside of the reflector, said component being parallel to the axis of revolution CC. This vector AB, as well as its component A′B′ parallel to the axis of revolution CC, which component A′B′ defines the direction of the annular louver members 102, is shown in FIG. 1a.

An annular louver member 102 comprises a bottom and a top surface. When the luminaire is placed outside in order to illuminate the ground, the bottom surface faces the ground whereas the top surface faces the sky. Due to many possible reflections on the annular louver members 102, light may exit the reflector upwardly, i.e. towards the sky. This leads to light pollution. Patent application EP 1 074 787 solves this problem in that the top surfaces of the annular louver members are provided with an absorbing material.

However, a large part of the light is absorbed by the top surfaces of the annular louver members. As a consequence, the ratio between the light emitted by the lamp and the light that is effectively used for illuminating the ground is low.

### SUMMARY OF THE INVENTION

It is an object of the invention to provide a reflector for a luminaire, which luminaire has an improved efficiency.

To this end, the invention proposes a reflector comprising a cavity for receiving a lamp intended to emit light and, located around said cavity, a first annular louver member arranged in a first direction and a second annular louver member arranged in a second, opposite direction.

The invention also proposes a luminaire comprising such a reflector, said luminaire comprising a reflective member for reflecting light coming from the second annular louver member.

According to the invention, the reflector is a combination of at least two annular louver members oriented in opposite direction. When a luminaire comprising such a reflector is used outside for illuminating the ground, the first annular member directs light towards the ground, while the second annular louver member directs light towards the sky. In other words, the mean direction of the light directed by the first annular louver member is the first direction and the mean direction of the light directed by the second annular louver member is the second direction. The luminaire comprises a reflective member, which reflects light emitted towards the sky towards the ground. As a consequence, no light is lost in this luminaire, and the efficiency of the luminaire is increased. Moreover, the light emitted towards the sky is controlled by the second annular louver member. This improves the illuminance uniformity on the ground. The light pollution is also reduced, because no light exits the luminaire towards the sky. Moreover, the control of light that is reflected towards the sky before being reflected towards the ground gives a nice decorative visual aspect of the reflective member, which is illuminated in a controlled way.

Advantageously, the cavity is closed at one side by a diffusive element. When the luminaire is placed outside for illuminating the ground, the diffusive element is placed on top of the cavity, i.e. between the reflector and the reflective member. This further improves the illuminance uniformity on the ground.

Preferably, the cavity is closed at one side by a colored element. As a consequence, colored light is projected on the reflective member, which enhances the decorative aspect of the luminaire.

Advantageously, the cavity is closed at one side by means for absorbing heat emitted by said lamp. This avoids overheating the reflective member or other components of the luminaire, which could damage the luminaire.

These and other aspects of the invention will be apparent from and will be elucidated with reference to the embodiments described hereinafter.

### BRIEF DESCRIPTION OF THE DRAWINGS

The invention will now be described in more detail by way of example with reference to the accompanying drawings, in which:

FIGS. 1a and 1b show a reflector in accordance with the prior art;

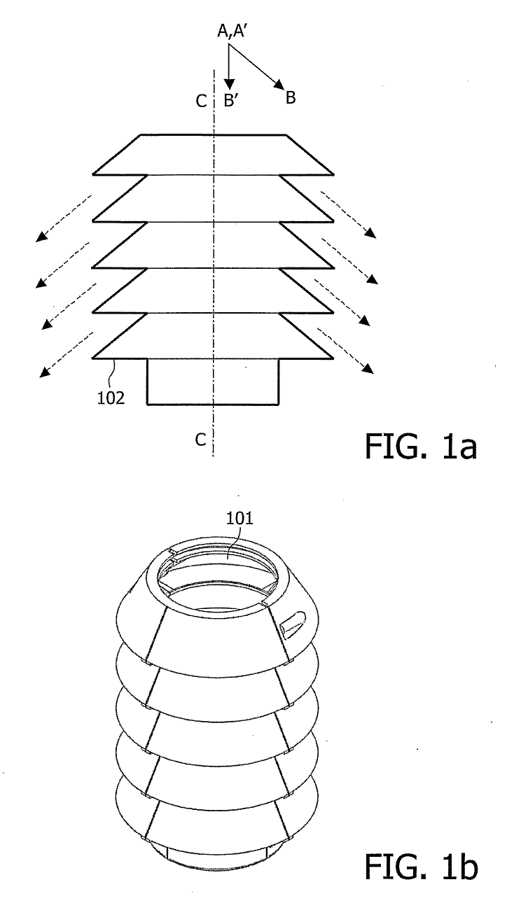

FIGS. 2a and 2b show a reflector in accordance with the invention;

FIG. 3 shows a luminaire in accordance with the invention.

### DETAILED DESCRIPTION OF THE INVENTION

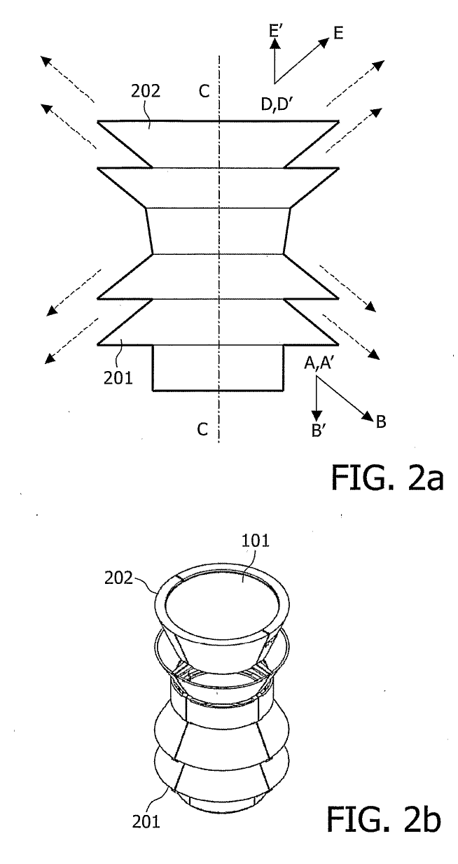

A reflector in accordance with the invention is depicted in FIGS. 2a and 2b, where FIG. 2a is a cross section and FIG. 2b a perspective view of said reflector. This reflector comprises a cavity 101 and, arranged around said cavity, a first annular louver member 201 and a second annular louver member 202. The first and second annular louver member 201 and 202 are symmetrical with respect to the axis of revolution CC. However, the first and/or second annular louver member 201 and/or 202 may be asymmetrical. An annular louver member is a louver member which is at least in part a surface of revolution.

The direction of the first annular louver member 201 is represented by the vector A′B′, whereas the direction of the second annular louver member 202 is represented by the vector D′E′. The directions of the first and second annular louver members 201 and 202 are opposite. As a consequence, a reflector in accordance with the invention leads to a controlled emission of light in two opposite solid angles, whereas the reflectors of the prior art lead to a controlled emission of light in only one solid angle. This property can be used, for instance, for illuminating two distinct surfaces with only one luminaire. For example, if one wants to illuminate two parallel walls in a room, the reflector can be placed horizontally and perpendicular to said two walls, so that the light coming from the first annular louver member will illuminate the first wall and the light coming from the second annular louver member will illuminate the second wall. Another application is the enlightening of a floor and a ceiling in a hall, or of the ground and the canopy when the reflector is placed under canopy.

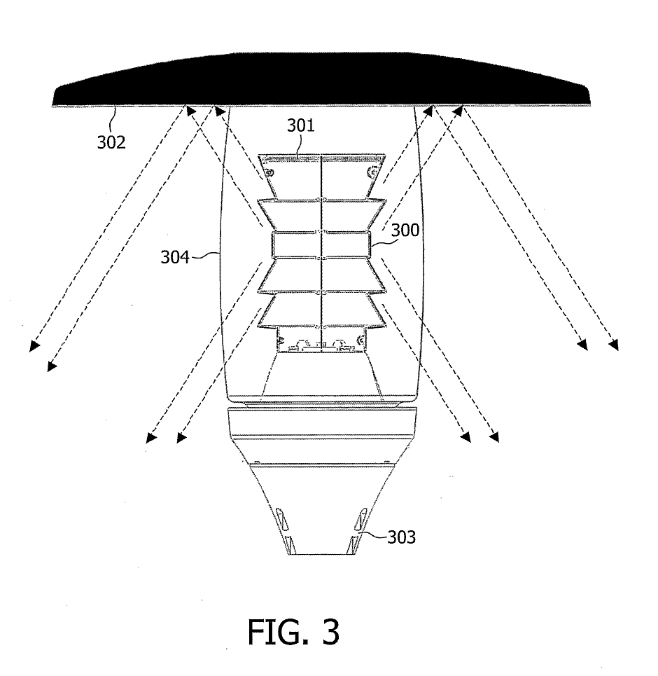

However, the reflector in accordance with the invention also advantageously replaces the reflectors of the prior art in luminaires intended to emit light in only one solid angle, as is explained in FIG. 3.

A luminaire in accordance with the invention is depicted in FIG. 3. This luminaire comprises a reflector 300 in accordance with the invention, an additional element 301, a reflective member 302, a base 303 and a light transmitting enclosure 304. The reflector 300 is similar to the reflector depicted in FIGS. 2a and 2b. The light transmitting enclosure 304 can be made of any transparent or semi-transparent material, such as glass or plastic. It can have many shapes, such a bowl or a cylinder for instance. The base 303 is intended for mounting the reflector 300 inside the luminaire, and may also be used for mounting the luminaire on a post or on a bracket on a wall. In the following example, the luminaire is mounted on a post for ground illumination in a public outside area. The base 303 is thus below the reflecting member 302. However, the luminaire of the invention may be used in many applications. In particular, it may be mounted on the ground for illumination of a ceiling or for façade enlightening. In this case, the base 303 will be above the reflective member 302.

Light that passes through the bottom part of the reflector 300, which comprises annular louver members oriented downwardly, is directed towards the ground. Light that passes through the top part of the reflector 300, which comprises annular louver members oriented upwardly, is directed towards the sky before being reflected towards the ground by the reflective member 302. Hence, the emission of light is controlled in the bottom part as well as in the top part of the reflector, and this ensures a good illuminance uniformity on the ground.

Moreover, the efficiency of the luminaire of FIG. 3 is improved with respect to a luminaire of the prior art, due to the control of emission of light in the top part of the reflector 300. Measurements have been performed on a luminaire as described in FIG. 3 and the same luminaire in which a reflector of the prior art has been placed instead of the reflector according to the invention. As the reflector of the prior art is opened at its top, a certain amount of light is directly emitted from the lamp towards the sky, and is thus reflected by the reflective member 302 towards the ground. However, this emission is not controlled, and this leads to a lower efficiency. It has been measured that the efficiency of the luminaire in accordance with the invention is improved by 25 percent with respect to the efficiency of the luminaire in accordance with the prior art.

The additional element 301 may be a diffusive element, a colored element or a partly refractive or reflective element. As light passes through said additional element 301, a diffusive element improves the illuminance uniformity of the light reflected downwardly and also the illuminance uniformity of the light on the reflective member 302, which enhances the decorative aspect of said reflective member 302. A colored element provides for colored light on the reflective member 302, which has a decorative effect. Moreover, a part of the light that illuminates the ground is colored, which allows modifying the color of the light that is used for illuminating the ground. A partly reflective or refractive element can comprise a pattern which is thus projected on the reflective member 302 and on the ground. The additional element is thus an element which modifies the light that comes from the second annular louver member 202.

The additional element 301 may also be a heat screen, which protects the top parts of the luminaire from heat generated by the lamp. This avoids for instance overheating of the reflective member 302, which could damage the luminaire.

Any reference sign in the following claims should not be construed as limiting the claim. It will be obvious that the use of the verb “to comprise” and its conjugations does not exclude the presence of any other elements besides those defined in any claim. The word “a” or “an” preceding an element does not exclude the presence of a plurality of such elements.

1. A reflector for a luminaire, said reflector comprising a cavity (101) for receiving a lamp intended to emit light and, located around said cavity, a first annular louver member (201) arranged in a first direction and a second annular louver member (202) arranged in a second, opposite direction.

2. A reflector as claimed in claim 1, wherein said cavity is closed at one side by a diffusive element (301).

3. A reflector as claimed in claim 1, wherein said cavity is closed at one side by a colored element (301).

4. A reflector as claimed in claim 1, wherein said cavity is closed at one side by means (301) for absorbing heat emitted by said lamp.

5. A reflector as claimed in claim 1, wherein said cavity is closed at one side by a partly reflective or refractive element (301).

6. A luminaire comprising a reflector as claimed in claim 1, said luminaire comprising a reflective member (302) for reflecting light coming from the second annular louver member.

7. A luminaire as claimed in claim 6, further comprising a diffusive element between the second annular louver member and the reflective member.

8. A luminaire as claimed in claim 6, further comprising a colored element between the second annular louver member and the reflective member.

9. A luminaire as claimed in claim 6, further comprising means for absorbing heat between the second annular louver member and the reflective member.

10. A luminaire as claimed in claim 6, further comprising a partly reflective or refractive element between the second annular louver member and the reflective member.
